(19) United States
(12) Patent Application Publication
(10) Pub. No.: US 2021/0190428 A1
(43) Pub. Date: Jun. 24, 2021

(54) WALL SYSTEM FOR A FURNACE, A FURNACE COMPRISING SUCH A WALL SYSTEM AND A METHOD FOR PROVIDING SUCH A WALL SYSTEM

(71) Applicant: Refractory Intellectual Property GmbH & Co. KG, Wien (AT)

(72) Inventor: Bojan Zivanovic, Wien (AT)

(21) Appl. No.: 16/078,547

(22) PCT Filed: Jun. 12, 2017
(86) PCT No.: PCT/EP2017/064305

§ 371 Date: Aug. 21, 2018

(51) Int. Cl. F27B 3/16; F27B 3/08; F27D 1/00; F27D 1/14

(52) U.S. Cl. CPC F27B 3/16; F27B 3/085; F27D 2001/0079; F27D 1/148; F27D 1/004

(57) ABSTRACT

The invention relates to a wall system for a furnace, a furnace comprising such a wall system and a method for providing such a wall system.

The invention relates to a wall system for a furnace, a furnace comprising such a wall system and a method for providing such a wall system.

A furnace has a furnace chamber, in which high temperatures can prevail. For example, high temperatures can be generated in the furnace chamber by means of aggregates, for example gas burners or arcs, in order to apply high temperatures to products in the furnace chamber. For example, molten products, for example molten metals, can also be embodied in the combustion chamber. A furnace chamber is frequently also identified as combustion chamber.

To enclose the furnace chamber and to delimit it from the environment, furnaces in each case have a furnace wall. Wall systems, which are embodied as combination of a metal wall and a refractory material arranged thereon, can be a part of such a furnace wall. The refractory material is thereby embodied on the inner side of the wall facing the furnace chamber and serves as refractory protective lining for the metal wall. As far as a good heat transfer from the furnace chamber through the wall system is required, to ensure such a good heat transfer, it is desirable for the refractory material to be mounted to the metal wall as holohedrally as possible. It is thus known to provide a refractory material on such a wall system as unformed refractory material, thus as so-called refractory mass, with which the inner side of the wall is coated. Compared to formed refractory materials, however, such unformed refractory materials have less resistance against infiltration and erosion. Accordingly, for most refractory applications, formed refractory materials, thus in particular refractory bricks, must be used to line the metal wall of the wall system. Various geometries of refractory bricks and wall are known from the prior art, which are to ensure a mounting, which is as holohedral as possible, of the refractory bricks to the wall. However, corresponding geometries of the bricks as well as of the wall can oftentimes only be embodied with high technical effort. Oftentimes, a permanent holohedral mounting of the bricks to the wall is furthermore virtually impossible in spite of corresponding complicated geometries. It is furthermore known from the prior art to clamp or screw refractory bricks to the wall by means of holding system, which actively impact the bricks, for example in the form of clamping means or screwing means. Due to thermal expansions, however, changes to the geometry of components of the furnace result during the operation of the furnace. These changes to the geometry can in particular also affect the wall and the refractory bricks arranged thereon. This is why bricks, which have a specific geometric shape, or clamping means, can also not always ensure a permanent holohedral mounting of the bricks to the wall.

The invention is based on the object of providing a wall system for a furnace, which can in particular encloses a furnace chamber as part of a furnace wall and which can delimit it from the environment, and which provides for a good heat transfer through the wall system. The invention is in particular based on the object of providing such a wall system, which is designed as simply as possible and which can in particular be provided with little technical effort. A further object of the invention is to provide such a wall system, which comprises a wall and refractory bricks, wherein the refractory bricks are mounted holohedrally to the wall. A further object of the invention is to provide such a wall system, which comprises a wall and refractory bricks, wherein the refractory bricks are still mounted holohedrally to the wall even after a longer operating time.

A further object of the invention is to provide a furnace comprising such a wall system.

A further object of the invention is to provide a method for installing such a wall system.

According to the invention, the basic idea for solving this object is to provide a wall system for a furnace, which comprises a wall and refractory bricks, which can be arranged on said wall, and in the case of which the force of gravity can be used to move bricks into a position, in which the bricks are mounted holohedrally to the inner side of the wall with one side. The bricks are kept in this position to ensure a continuous holohedral mounting of the bricks to the wall.

Based on this basic idea, what is provided to solve the above-identified object is a wall system for a furnace, which comprises the following features:

A wall, which has an inner side facing the furnace chamber and an outer side facing the environment;

a heat-conducting layer, which is arranged on the inner side of the wall;

bearing surfaces, which are embodied on the inner side of the wall;

refractory bricks, which in each case have an opening, which goes through the brick, are arranged next to one another in at least one row, in each case have a side, which faces the inner side of the wall and which can be mounted holohedrally to the heat-conducting layer, wherein the openings of the bricks, which are in each case arranged next to one another in a row, are aligned with one another;

rods, which are in each case guided through the aligned openings of the bricks, which are arranged next to one another in a row, and which in each case bear on a number of the bearing surfaces;

wherein the bricks, which are in each case arranged next to one another in a row, can be moved from a first position, in which a clearance is embodied between the bricks and the heat-conducting layer, into a second position, in which the bricks are mounted holohedrally to the heat-conducting layer with their side, which faces the inner side of the wall, by means of the force of gravity.

A correspondingly embodied wall system makes it possible for the bricks to be capable of being moved into a position, in which the bricks are mounted holohedrally to the heat-conducting layer on the inner side of the wall with their side, which faces the inner side of the wall, by means of the force of gravity.

This is possible, for example, in that the bricks, which are in each case arranged next to one another in a row, have elongated holes which go through the bricks and through which the rods are guided.

Alternatively, this is possible, for example, in that the bricks bear on the bearing surfaces, which run inclined downwards towards the inner side of the wall, by means of the rod, which is guided through the openings of these bricks, and can be moved diagonally downwards towards the wall via the rod on these bearing surfaces.

Accordingly, the bricks can be moved into a position, in which the bricks are mounted holohedrally to the heat-conducting layer on inner side of the wall with their side, which faces the inner side of the wall, by means of the force of gravity. A holohedral mounting of the refractory bricks to the heat-conducting layer on the inner side of the wall is thus ensured in this position, because the force of gravity holds the refractory bricks in this position.

To keep the bricks in the second position, restraining means can be provided, being capable of keeping the bricks in the second position so that a permanent holohedral mounting of the bricks to the wall is ensured in any position of the wall and thus, for example, even if the force gravity does not force the bricks against the heat-conducting layer any more. This might be the case, for example, when the wall system is moved into a generally horizontal position, for example when the wall system is used as a roof of a furnace.

Within the meaning of the present invention, the wall system of the present invention is any part of a furnace wall enclosing the furnace chamber and delimiting the furnace chamber from the environment. Accordingly, the wall system can be, for example, a part of the side wall of a furnace wall or a part of the roof of a furnace wall.

On principle, the wall system according to the invention is usable for any furnace, in particular for any industrial furnace. The wall system can in particular be used for an industrial furnace for melting and treating metals, for example for the side walls or the roof of an electric arc furnace for melting metals or for the roof of round shaft furnaces.

The wall of the wall system can in particular be made of metal, for example of steel or copper, preferably of steel. The inner side of the wall facing the furnace chamber can preferably be embodied as flat surface, which preferably extends in a vertical plane. Such a flat wall can be embodied in a particularly simple manner. Such a flat wall surface can furthermore ensure that a side of the brick, which is also embodied so as to be flat and which is mounted to the wall, is always mounted holohedrally to the heat-conducting layer on the inner side of the wall, even in response to a change to the geometry of the wall resulting from a thermal expansion of the wall. The outer side of the wall can preferably have cooling agents for cooling the wall. Such cooling of the wall might especially be necessary to protect any parts of the wall system which can be made of metal, so for example the wall, the bearing surfaces, the rods or the restraining means. For example, the outer side of the wall can have cooling agents in the form of cooling ribs. In the alternative or cumulatively, the outer side of the wall can have cooling agents through which a fluid can flow, thus for example cooling agents, which have guide means for conveying a cooling agent, for example a cooling agent in the form of water.

To allow movement of the bricks from the first to the second position, the bricks might have elongated holes, i.e. slotted holes (long holes), which go through the bricks and through which the rods are guided. Accordingly, when the rods are guided through such elongated holes, the elongated holes allow the bricks to move from the first position to the second position.

According to a preferred embodiment, however, to allow movement of the bricks from the first to the second position, the bearing surfaces are provided such that they allow the rods, bearing on the bearing surfaces, movement on the bearing surfaces such that the bricks, through the openings of which the rods are guided, can move from the first to the second position.

To this end, according to a preferred embodiment, the bearing surfaces run inclined downwards towards the inner side of the wall. At this embodiment, the bearing surfaces not only serve to support the rods, on which the refractory bricks are arranged, but serve as guiding means or rails allowing the rods moving downwards towards the inner side of the wall. The bearing surfaces can run in the form of an inclined plane, a curved surface or in the form of a curve-shaped surface, for example. However, the bearing surface preferably runs inclined downwards towards the inner side of the wall at every area, thus with a slope towards the wall. This ensures that the refractory bricks arranged on the rods can always be moved into the second position, in which the bricks are mounted holohedrally to the heat-conducting layer at the inner side of the wall with their side, which faces the inner side of the wall, by means of the force of gravity, when the rods bear on the bearing surfaces.

Preferably, an angle in the range from 5° to 45° is enclosed between each bearing surface and the wall. If the angle is smaller than 5°, the bearing surfaces would have to be provided too long to ensure a movement of the bricks from the first into the second position. If the angle is larger than 45°, however, it might be the case that the force of gravity will not move the bricks from the first into the second position. More preferably, an angle in the range from 5° to 30° is enclosed between the bearing surfaces and the wall. In case the bearing surfaces does run in the form of an inclined plane but, for example in the form of a curved surface, and, hence, different angles are enclosed between the bearing surfaces and the wall, it is preferably provided that such each of such angles is within the above range.

Provision is preferably made for at least two bearing surfaces to be arranged at the same height in each case. This ensures that a rod arranged on these bearing surfaces at the same height can be placed onto these bearing surfaces in a horizontal position. To prevent an excessive bending of the rods under the load of the refractory bricks, for example in the case of longer rods, three or more bearing surfaces comprising a rod placed thereon can also be arranged on the inner side of the wall at the same height.

The bearing surfaces are preferably arranged at different heights, particularly preferably, at least two bearing surfaces are in each case arranged at different heights. Thus, rods comprising bricks arranged thereon can in each case be placed horizontally onto the at least two bearing surfaces at different heights.

The bearing surfaces are preferably embodied at different heights, which are spaced apart evenly from one another.

The bearing surfaces furthermore each have the same distance from one another, preferably at each of the different heights.

The bearing surfaces are each furthermore preferably embodied uniformly, they thus in particular each have the same design, i.e. the same geometrical design.

To be able to fulfill these features of the arrangement of the bearing surfaces, provision can be made according to a preferred embodiment for a first number of bearing surfaces to be arranged on a first area of the inner wall and for a second number of bearing surfaces to be arranged on a second area of the inner wall, wherein the first number of bearing surfaces is arranged vertically on top of one another at the same distance from one another and the second number of bearing surfaces is arranged vertically on top of one another and in each case at the same height as the first number of bearing surfaces.

The bearing surfaces can be embodied on molds, which can be arranged on the inner side of the wall. For example, these molds can in each case be embodied in the form of rods, bolts or plates, which can in each case be embodied on the inner side of the wall and which can in each case have a bearing surface embodied according to the invention on their upper side.

According to a preferred embodiment, the bearing surfaces are embodied as the bottom side of elongated holes. Each bearing surface is thus in each case the lower surface of an elongated hole, which is embodied in a mold. These elongated holes can be embodied in molds as they are disclosed herein, for example. The advantage of such elongated holes for embodying bearing surfaces is in particular also that the rods are held securely in the elongated holes and that the rods are in particular prevented from inadvertently popping out of the bearing surfaces.

For embodying such elongated holes, provision is made according to a preferred embodiment for at least two metal plates, which, spaced apart from one another horizontally, are in each case arranged vertically on the inner side of the wall. These metal plates can in each case be arranged perpendicularly to the inner side of the wall and can have elongated holes, the respective lower surface of which in each case forms a bearing surface. The elongated holes are preferably in each case embodied uniformly, so that the bearing surfaces are in each case embodied uniformly as well.

Preferably, a first number of elongated holes is embodied on a metal plate and a second number of elongated holes is embodied on a second metal plate, wherein the first number of elongated holes is embodied vertically on top of one another at the same distance from one another and the second number of elongated holes is embodied vertically on top of one another and in each case at the same height as the first number of elongated holes.

A heat-conducting layer is arranged on the inner side of the wall. This heat-conducting layer ensures a good heat conduction from the bricks to the wall when the bricks are in the second position, i.e. when the bricks are contacting holohedrally the heat-conducting layer with their side which faces the inner side of the wall. Preferably, the inner side of the wall is covered all-over with the heat-conducting layer or at least at all areas where the bricks are capable of contacting the heat-conducting layer in the second position.

The heat-conducting layer can be made of any material with good heat-conducting properties. Preferably, the heat-conducting layer is made of a material which is able of withstanding temperatures up to 90° C. Preferably, the heat-conducting layer is thin and has, for example, a thickness in the range from 1 to 5 mm, more preferably in the range from 1 to 3 mm.

According to a preferred embodiment, the heat-conducting layer is made of a flexible material. One main advantage of such a heat-conducting material consisting of a flexible material is that a holohedral contact between the heat-conducting material and the bricks is ensured even in case of changes to the geometry of components of the wall system during the operation of the wall, for example due to thermal expansions. Such a flexible material can be, especially preferred, a flexible mortar. Such a flexible mortar can preferably be provided in the form of plastic mortar. Such plastic mortars are known in the art. Generally, such plastic mortars are made of a refractory raw material and a binder, especially an organic binder which keeps its plastic properties even during use of the mortar. According to a particularly preferred embodiment, the heat-conducting layer is made of carbon based mortar. Such carbon based mortar can consist of a carbon component as refractory raw material and a binder component, preferably an organic binder such as a resin. The carbon component may be provided in the form of graphite. Such a heat-conducting layer, made of graphite and an organic binder, ensures an excellent heat conduction between the bricks and the wall, withstands temperatures up to 90° C. and shows highly flexible properties which are kept during the use thereof.

To protect the inner side of the wall of the wall system facing the furnace chamber by means of a refractory material, refractory bricks are provided on this inner side of the wall facing the furnace chamber.

The refractory bricks are arranged next to one another in at least one row and in each case have an opening, which goes through the brick. These openings of the bricks, which are in each case arranged next to one another in a row, are aligned with one another, wherein a rod is in each case guided through the openings, which are aligned with one another, of the bricks arranged next to one another in a row. In other words, the bricks in one row are in each case attached to a rod.

Provision is preferably made for the bricks, which are arranged next to one another in a row, to be mounted next to one another without joints, i.e. with “dry joints”, wherein adjacent bricks are in direct contact with each other without any mortar or the like in the joints. For this purpose, the bricks in one row can in each case have surfaces, which face one another and which can be mounted to one another without joints. The bricks, which are arranged next to one another in a row, in each case preferably have flat surfaces facing one another. Bricks comprising such flat surfaces can be produced in a particularly simple manner.

The bricks in each case have a side, which faces the inner side of the wall and which can be mounted holohedrally to the heat-conducting material on the inner side of the wall. The side of the bricks facing the inner side of the wall is thus embodied in such a way that it can be mounted holohedrally, thus without joints, to the heat-conducting material. A particularly effective heat transfer between the refractory bricks and the heat-conducting material can thus be established. To be able to holohedrally mount the side of the bricks facing the inner side of the wall to the heat-conducting material, the wall and the bricks have surfaces, which face one another. According to a preferred embodiment, the inner side of the wall as well as the side of the bricks facing the wall is in each case embodied so as to be flat. The advantage of this embodiment, in turn, is in particular that the wall and the bricks can be produced in a particularly simple manner from a technical aspect. On the other hand, it can be assured through this, as specified above, that the bricks are always mounted holohedrally to the heat-conducting material on the inner side of the wall even in response to a change to the geometry of the wall or further components of the wall system, resulting from a thermal expansion of the wall or such components.

The rods, to which the bricks, which are arranged next to one another in a row, are attached in each case, can preferably be made of steel, preferably high temperature resistant steel. The rods in each case bear on a number of the bearing surfaces. It may be sufficient thereby, if the rods bear on at least two bearing surfaces. These bearing surfaces are horizontally spaced apart from one another and are preferably embodied at the same height, so that the rod, which bears on the bearing surfaces, and thus also the bricks, which are attached to the rod, are oriented horizontally.

In that according to the invention a rod is now in each guided through the openings, which are aligned with one another, of the bricks arranged next to one another in a row, and in that the rods in each case simultaneously bear on at least two bearing surfaces, which run diagonally downwards towards the inner side of the wall, this makes it possible for the rods, which are in each case arranged next to one another in a row, to be capable of being moved from a first position, in which a clearance is still embodied between the bricks and the inner side of the wall can be moved into a second position, in which the bricks are mounted holohedrally to the heat-conducting material on the inner side of the wall with their side facing the inner side of the wall, by means of the force of gravity. In this respect, the bearing surfaces serve as a type of rail system, via which the bricks glide diagonally, i.e. diagonally downwards towards the inner side of the wall from a first position, in which the bricks are still arranged at a distance to the inner side of the wall, thus a clearance or a gap, respectively, being embodied between the bricks and the inner side of the wall, by means of the rods, to which they are attached and which bear on the bearing surfaces, into a second position, in which the bricks are mounted holohedrally to the heat-conducting material on the inner side of the wall with their side, which faces the inner side of the wall, by means of the rods on the bearing surfaces as a result of the force of gravity, and a heat transition between the inner side of the wall and the bricks is thus allowed by the heat-conducting material.

According to a preferred embodiment, provision is made for the refractory bricks to embody masonry on the inner side of the wall. Provision can be made for this purpose for a plurality of rows of bricks, which are arranged next to one another, as specified herein, to be embodied on top of one another on the inner side of the wall. According to the invention, each of these rows of bricks, which are arranged next to one another, can thus be moved from the first position according to the invention into the second position according to the invention by means of the force of gravity.

Provision is thereby preferably made for the sides of the bricks in a row, which face the sides of the bricks of a row, which is adjacent thereto, to be capable to be mounted holohedrally to one another in each case. Adjacent rows of bricks can thus be mounted holohedrally to one another, thus with dry joints, i.e. with direct contact of adjacent bricks and without mortar in the joint between such adjacent bricks. In that the bricks, which are arranged next to one another in a row, are mounted holohedrally to one another simultaneously, the refractory bricks as a whole—in each case in the second position—can preferably embody masonry on the inner side of the wall with dry joints in this respect.

Because of such masonry with dry joints, the furnace chamber is enclosed particularly effectively by the wall system and it is prevented through this that too high amounts of radiant heat, hot gases or a liquid molten metal, for example, comes into contact with the wall. Such masonry with dry joints simultaneously ensures a good heat transfer through the wall system.

The sides of the bricks in a row, which face the sides of the bricks in an adjacent row, are in each case preferably embodied so as to be flat. This has the advantage that the bricks can be produced in a particularly simple manner from a technical aspect.

The wall system according to the invention makes it possible in this respect for the refractory bricks of the wall system as a whole to be embodied in a generally cuboidal manner. Provision is thus made in a particularly preferable manner for the refractory bricks of the wall system according to the invention to have a generally cuboidal shape. Such cuboidal refractory bricks can be produced in a particularly simple manner from a technical aspect.

According to a preferred embodiment of the invention, provision is made for the refractory bricks of the wall system to have the same dimension in each case. Only a single brick shape needs to be provided in this respect so as to line the wall of the wall system according to the invention with refractory bricks on the inner side thereof. Such an embodiment can be produced in a particularly simple manner from a technical aspect.

On principle, the refractory bricks can consist of any refractory material, in particular a refractory ceramic material. According to an embodiment, the refractory bricks consist mainly of refractory oxidic raw materials, in particular refractory oxidic raw materials of one or a plurality of the oxides MgO, Al₂O₃, SiO₂, ZrO₂, Cr₂O₃, CaO or Fe₂O₃. Provision may be made for at least 70% by weight of the refractory bricks or also at least 80% by weight, based on the weight of the refractory bricks, to consist of these oxides. In addition to the above-identified oxides, the refractory bricks can also comprise non-oxidic, ceramic materials, for example carbides, for example silicon carbide. Insofar as the refractory bricks are present as carbon-bonded bricks, the refractory bricks can have free carbon, for example in proportions in the range of between 1 and 30% by weight, in particular in the range of between 1 and 20% by weight.

Preferably, the bricks have a thickness (i.e. a length between the hot side of the bricks, facing the furnace chamber, and the opposite cold side of the bricks, facing the wall) in the range from 100 to 400 mm.

Preferably, the wall system comprises restraining means by means of which the bricks can be restrained in the second position. Accordingly, the restraining means are capable of restraining the bricks holohedrally to the heat-conducting layer with their side facing the inner side of the wall and, hence, ensure that the bricks are contacting permanently and holohedrally the heat-conducting layer with their side facing the inner side of the wall. According to a preferred embodiment, the restraining means are provided as locking means, locking the bricks in the position in which they are contacting holohedrally the heat-conducting layer. Preferably, the restraining means force the bricks in the same direction as the force of gravity; insofar, the restraining means “replace” the force of gravity when the wall system is moved to such a position that the force of gravity does not move the bricks any more into the second position. This might be the case, for example, when the wall system is moved into a mainly horizontal position, for example when the wall system is used as a roof of a furnace.

According to one preferred embodiment, the restraining means are provided as at least one plate which is pushed against the bricks. As set forth above, such at least one plate pushes the bricks holohedrally to the heat-conducting layer with their side facing the inner side of the wall. Preferably the plate pushes the bricks in the same direction as the force of gravity when the same moves the bricks in the second position. Such at least one plate preferably can be provided as a metal plate.

According to one preferred embodiment, if the bricks embody masonry on the inner side of the wall, the restraining means are provided as a metal plate which is pushed against the uppermost row of bricks in said masonry. In such embodiment, when the metal plate restrains the bricks of the uppermost row in the second position, i.e. in the position holohedrally mounted to the heat-conducting layer, the rows of bricks below said uppermost row in said masonry are restrained in the second position, i.e. in the position holohedrally mounted to the heat-conducting layer, as well through the interaction of the bricks in the masonry. Preferably, in such embodiment, the plate is pushed against the upper side of the bricks of the uppermost row.

The restraining means, especially in the form of a metal plate, can be attached to the wall, especially to the inner side of the wall. Insofar, the restraining means can be attached to any components, provided at the inner side of the wall, especially to molds. According to a preferred embodiment, the restraining means are attached to molds, provided at the inner side of the wall, preferably the molds and on which the bearing surfaces are embodied. The restraining means can be attached to the wall by any fastening means, for example welding, clamping means or screwing means. According to a preferred embodiment, the restraining means are welded to molds, provided at the inner side of the wall, and on which the bearing surfaces are embodied.

A furnace, which comprises a wall system according to the invention, is also a subject matter of the invention.

According to an embodiment, the furnace comprises a furnace wall, which encloses a furnace chamber of the furnace and delimits it from the environment, wherein the furnace wall is embodied in the form of a wall system according to the invention at least section by section and wherein the inner side of the wall of the wall system faces the furnace chamber and the outer side of the wall of the wall system faces the environment.

On principle, the furnace according to the invention can be any furnace, in particular any industrial furnace. Preferably, the furnace according to the invention is a furnace for melting or for treating metal, in particular non ferrous and ferro alloys. According to an embodiment, the furnace according to the invention is flash smelting furnace.

A further subject of the present invention is a method for installing a wall system according to the present application, comprising the following steps:
Providing a wall system, according to the present invention;
positioning the bricks in the first position;
moving the bricks into the second position.

As set forth herein, in the wall system of the present invention, the bricks will move from the first position into the second position by force of gravity.

In a further step, following the step of moving of the bricks into the second position, the bricks can be restrained in the second position. Preferably, as set forth above, the bricks can be restrained in the second position by said restraining means, which, preferably, force the bricks in the same direction as the force of gravity and, insofar, “replace” the force of gravity when the wall system is moved to such a position that the force of gravity does not move the bricks any more into the second position. To restrain the bricks in the second position, the restraining means can be attached to the wall system, as set forth herein.

Further features of the invention follow from the claims as well as from the below-described exemplary embodiment of the invention.

All of the features of the invention may be combined with one another arbitrarily, either alone or in combination.

An embodiment of a wall system according to the invention is specified in more detail in the exemplary embodiment below.

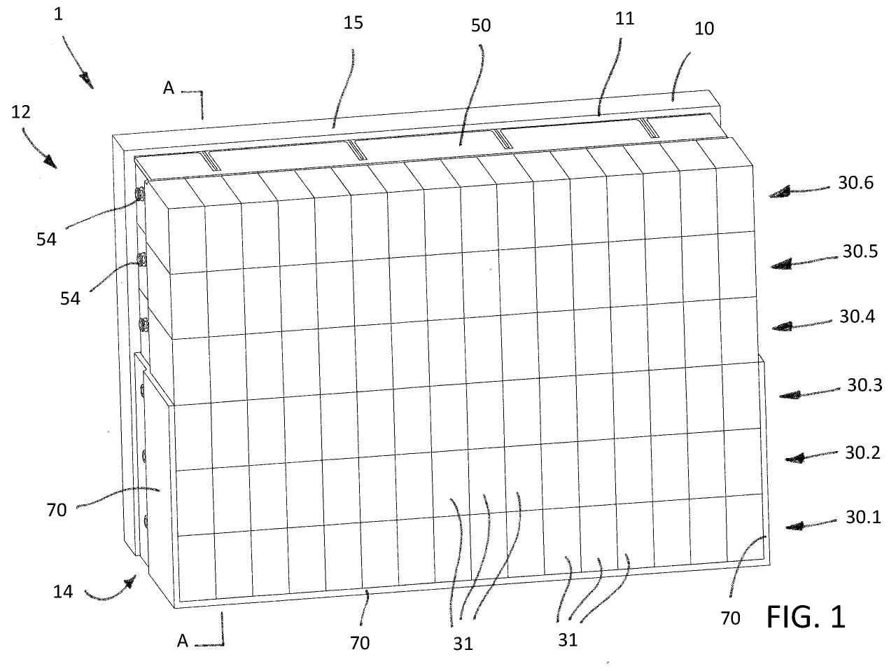

FIG. 1 shows a wall system in a perspective view,

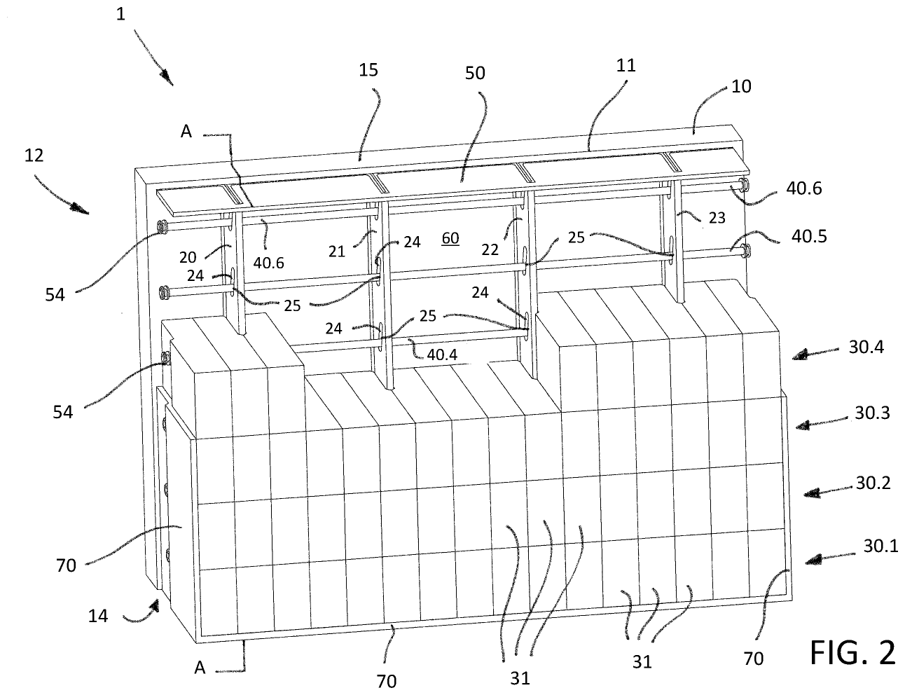

FIG. 2 shows the wall system according to FIG. 1 in the same illustration as in FIG. 1, but wherein only the first three rows of bricks have been installed completely,

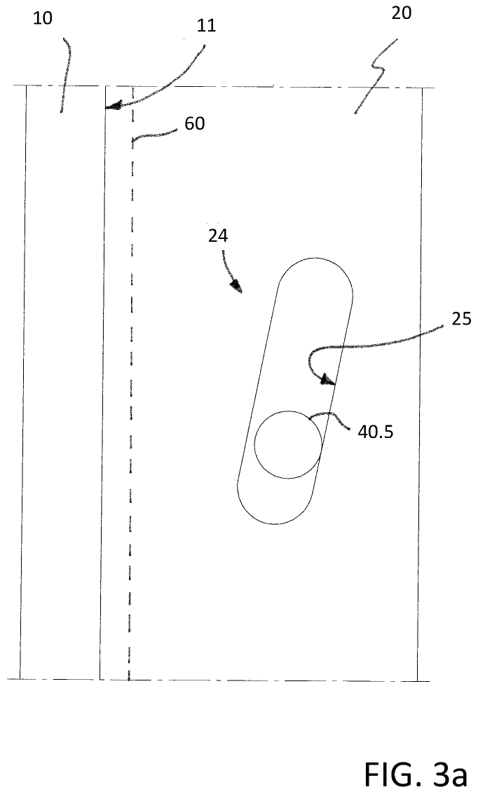

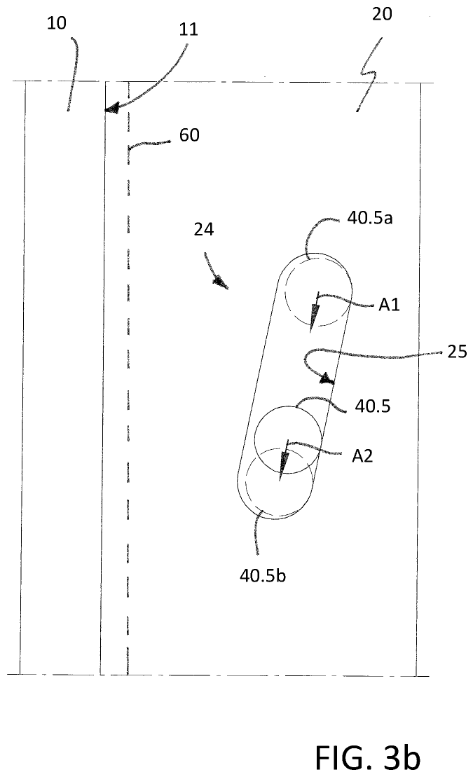

FIG. 3a shows an area around an elongated hole of a wall system according to FIG. 1 in a lateral view,

FIG. 3b shows the area according to FIG. 3a, but with indicated alternative positions of the rod in the elongated hole,

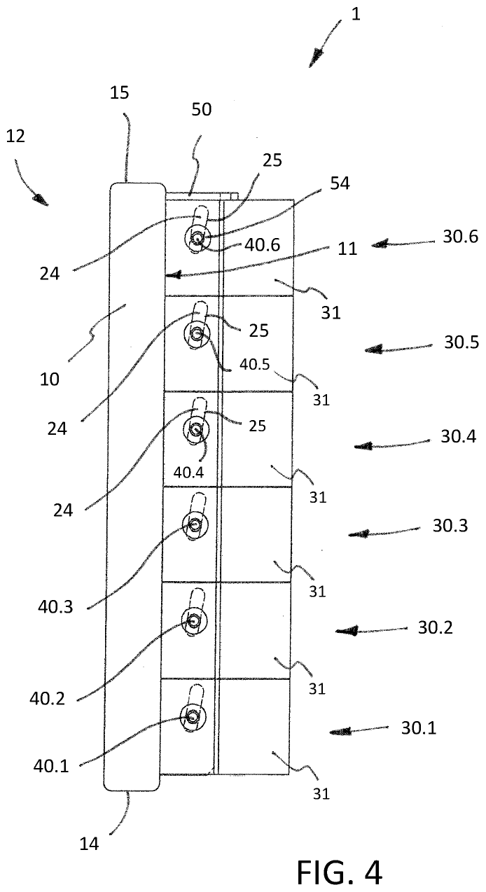

FIG. 4 shows the wall system according to FIG. 1 in a lateral view,

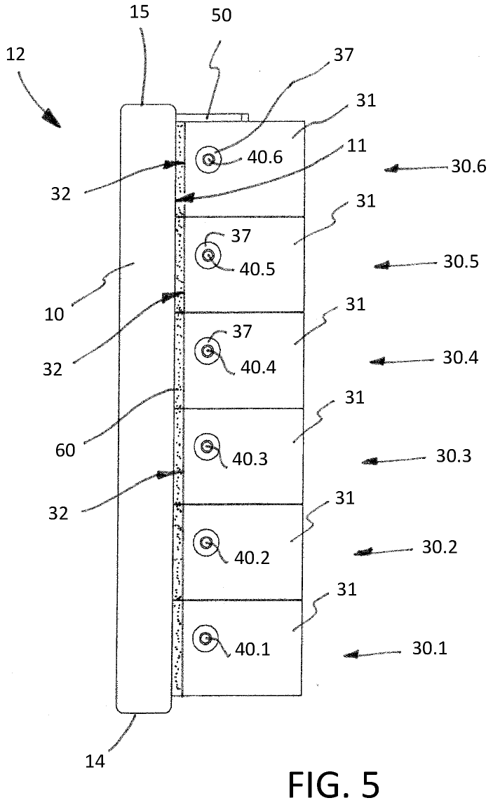

FIG. 5 shows the wall system according to FIG. 1 in a lateral view according to the sectional line A-A according to FIG. 1, and

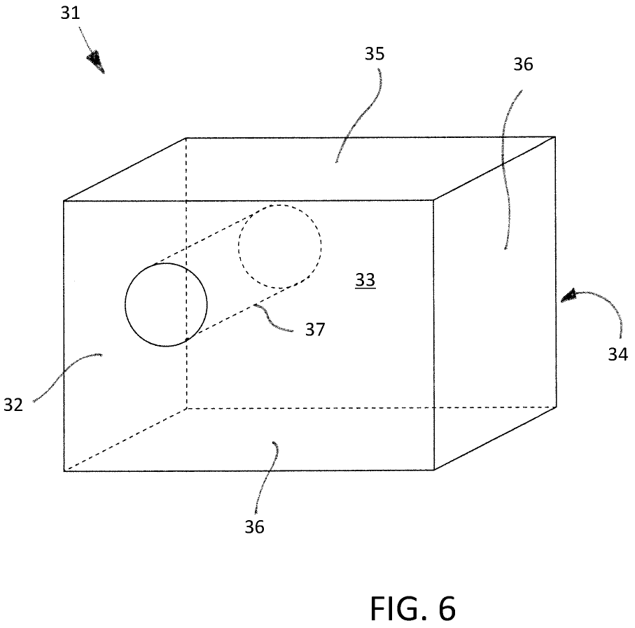

FIG. 6 shows a refractory brick of the wall system according to FIG. 1 in a perspective view.

Parts, which have the same effect, have partially also been identified with the same reference numerals in the figures.

The wall system in its totality has been identified with reference numeral 1 in the figures. The wall system 1 is part of a furnace wall.

The wall system 1 has a steel wall 10 made of steel. The wall 10 has an inner side 11 facing the furnace chamber and an outer side 12 facing the environment. Inside the wall 10 there are provided guide means in the form of channels (not shown) for conveying a cooling agent in the form of water.

The inner side 11 of the wall 10 is embodied as flat, vertical surface. The wall 10 as a whole substantially has a tabular design comprising an outer edge extending in a rectangular manner.

The inner side 11 of the wall 10 is coated with a heat-conducting layer 60. The heat-conducting layer 60 is provided as a plastic mortar consisting of 95% by mass of graphite and of 5% by mass of an organic binder. The thickness of the layer 60 is about 1 to 2 mm.

Four metal plates 20, 21, 22, 23 which are horizontally spaced apart from one another and which are in each case arranged perpendicularly to the inner side 11 of the wall 10 and which extend vertically from the area of the inner side 11 of the wall 10 adjacent to the lower edge 14 of the wall 10 to the area of the inner side 11 of the wall 10 adjacent to the upper edge 15 of the wall 10, are in each case welded to the inner side 11 of the wall 10 as molds.

On the upper end of the metal plates 20, 21, 22, 23 a horizontally extending metal plate 50 is welded to the metal plates 20, 21, 22, 23. As set forth further below, the metal plate 50 is provided as restraining means by means of which the bricks 31 of the wall system 1 can be restrained in the second position.

Six elongated holes 24, of which only the respective three uppermost elongated holes 24 can be seen in FIG. 2, are embodied at the same distance from one another on top of one another in the metal plates 20, 21, 22, 23. The elongated holes 24 of the metal plates 20, 21, 22, 23 are in each case embodied uniformly and at the same height. It can be seen in FIG. 2 that four elongated holes 24 are in each case embodied at the same height. The bottom side of the elongated holes 24 in each case forms a bearing surface 25, which in each case runs inclined downwards towards the inner side 11 of the wall 10, according to the course of the elongated holes 24. To better illustrate the wall system 1 in the figures, the bricks 31, which are actually attached to the rods 40.6, 40.5, and part of the bricks 31, which are actually attached to the rod 40.4, are not illustrated in FIG. 2.

FIG. 3a illustrates an area around any of the elongated holes 24 in a lateral view. The course of the elongated hole 24 inclined downwards towards the inner side 11 of the wall 10 can be seen well, whereby the bottom side of the elongated hole 24 thus also forms a bearing surface, which runs inclined downwards towards the inner side 11 of the wall 10 and which is identified with reference numeral 25. Due to the identical dimensioning of all elongated holes 24, the bearing surfaces 25 of all elongated holes 24 are embodied accordingly.

An angle of 12° is enclosed between the bearing surfaces 25 and the inner side 11 of the wall 10.

The wall system 1 has six rows 30.1-30.6, which are arranged on top of one another, consisting of refractory bricks 31, which are in each case arranged next to one another. Each row 30.1-30.6 is in each case formed from sixteen refractory bricks 31, which are arranged next to one another. The refractory bricks 31 in each case consist of a refractory ceramic material on the basis of magnesia (MgO). All refractory bricks 31 are dimensioned generally identically and in each case have a generally cuboidal shape (only the bricks adjacent to the metal plates 20, 21, 22, 23 have notches for a form-fit positioning of the metal plates 20, 21, 22, 23 in the masonry). A refractory brick 31 of the wall system 1 is illustrated in a perspective view diagonally from the top in FIG. 6. According to this, each of the refractory bricks 31 has six flat sides, namely one side 32 (“cold side” of the bricks 31), which faces the inner side 11 of the wall 10 and which can be mounted holohedrally thereto, lateral sides 33, 34, which in each case face the adjacent bricks 31 in the respective row 30.1-30.6, an upper side 35 and a bottom side 36, which in each case faces the bricks 31 of the adjacent row 30.1-30.6, as well as a side 26 (“hot side” of the bricks 31), which faces the furnace chamber. The thickness of the bricks 31, i.e. the length of the bricks 31 from the cold side 32 to the hot side 34, is 300 mm.

Furthermore, the bricks 31 in each case have a circular cylindrical opening 37, which goes through the brick 31, wherein the bricks 31 in each of the rows 30.1-30.6 are in each case arranged next to one another in such a way that the openings 37 of the bricks 31, which are in each case arranged next to one another in a row 30.1-30.6, are aligned with one another.

A rod 40.1-40.6 made of steel is in each case guided through the openings 37, which are aligned with one another, of the bricks 31 in each of the rows 30.1-30.6.

Each of the rods 40.1-40.6 in each case bears on four bearing surfaces 25 simultaneously, which are in each case formed by four elongated holes 24 at the same height. The rods 40.1-40.6 comprising the refractory bricks 31, which are attached thereto, are in each case oriented horizontally through this.

As can be well seen in FIG. 2, the refractory bricks 31, which are in each case arranged next to one another in a row 30.1-30.6, in each case bear on the bearing surfaces 25 via the rods 40.1-40.6, which are in each case guided through the openings 37 of these refractory bricks 31. Due to the fact that the bearing surfaces 25 of the elongated holes 24 in each case run inclined downwards towards the inner side 11 of the wall 10, these bearing surfaces 25 serve as a rail system, on which the bricks 31 can glide or slide, respectively, diagonally downwards towards the inner side 11 of the wall 10 on these bearing surfaces 25. The bricks 31, which are in each case arranged next to one another in a row 30.1-30.6, can thereby in each case be moved from a first position, in which a clearance is embodied between the bricks 31 and the inner side 11 of the wall 10 (not illustrated in the figures) by means of the force of gravity acting on the bricks 31 and the rods 40.1-40.6, into the second position, which is illustrated in the figures, in which the bricks 31 are mounted holohedrally to the heat-conducting layer 60, attached to the inner side 11 of the wall 10, with their side 32, which faces the inner side 11 of the wall 10.

To secure the bricks 31 on the rods 40.1-40.6, a disk-shaped head piece 54 is in each case fastened to the respective end of the rods 40.1-40.6.

The position of the rod 40.5, which is assumed on the bearing surface 25 when the bricks 31 are in the second position illustrated in the figures, is illustrated by means of a circle comprising a continuous line in FIGS. 3a and 3b. The position of the rod 40.5, which is assumed on the bearing surface 25 when the bricks 31 are in the first position, is illustrated by means of a circle comprising a dashed line, indicated with 40.5a in FIG. 3b. An arrow A1 indicates how the rod 40.5 moves on the bearing surface 25, when the bricks 31 move from the first into the second position by means of the force of gravity. The movement of the further rods 40.1-40.4, 40.6 is equivalent thereby.

As can be seen in FIGS. 3a and 3b, when the bricks 31 are in the second position, the rod 40.5 is resting on the bearing surface 25 with clearance. Accordingly, the rod 40.5 is resting on the bearing surface 25 such that a further movement of the rod 40.5 towards the inner side 11 of the wall 10, indicated by the arrow A2, in a position, indicated with dashed line 40.5b in FIG. 3b, is possible. This allows movement of the bricks 31 due to thermal expansion, even though the bricks 31 are restrained in the second position by the restraining means, i.e. metal plate 50 in the illustrated embodiment.

In the exemplary embodiment, the wall system 1 is dimensioned in such a way that the refractory bricks 31 as a whole form masonry with dry joints. This is made possible by means of the generally cuboidal shape of the bricks 31, because the refractory bricks 31, which are arranged next to one another in a row 30.1-30.6 are in each case mounted holohedrally to one another with their sides 33, 34, which face one another, and the sides 35, 36 of adjacent rows 30.1-30.6.

The restraining means, provided as the metal plate 50 being screwed to the upper end of the metal plates 20, 21, 22, 23 is pushed against the uppermost row 30.6 of bricks 31 in said masonry. Accordingly, the uppermost row 30.6 of bricks 31 and, due to said masonry, the rows 30.1-30.5 of bricks 31 below said uppermost row 30.6 in said masonry are restrained in the second position, i.e. in the position in which the bricks holohedrally are in contact to the heat-conducting layer.

At its four lateral surfaces (left and right lateral surfaces as well as the upper and lower surface), the masonry is covered with a refractory fibrous material 70. For illustrating purposes, fibrous material 70 is only illustrated in parts in FIGS. 1 and 2. The fibrous material 70 acts as an expansion joint between the wall system 1 elements, adjacent to the walls system 1 in a furnace wall.

The wall system 1 is illustrated in a lateral view in FIG. 4.

In FIG. 5, the wall system is illustrated in a lateral view according to the sectional line A-A according to FIG. 1. It can be seen well that the side 32 of the bricks 31, which in each case faces the inner side 11 of the wall 10, is in each case mounted holohedrally to the heat-conducting layer 60 at the inner side 11 of the wall 10.

A method for installing the wall system according to the illustrated embodiment, comprises the following steps:

Providing the wall system 1 according to the disclosed embodiment (but without the metal plate 50);

positioning the bricks 31 in the first position;

moving the bricks 31 into the second position;

welding the metal plate 50 to the upper end of the metal plates 20, 21, 22, 23.

In detail, at first a substructure (not illustrated), onto which the lowermost row 30.1 made of refractory bricks 31 is placed in such a way that the openings 37 of the refractory bricks 31 are aligned with one another as well as with the four lowermost elongated holes 24, is initially constructed in the area of the lower edge 14 of the wall 10 so as to produce the wall system 1 illustrated in the exemplary embodiment. A rod 40.1 is subsequently guided through these openings 37 and the elongated holes 24. On the lowermost row 30.1, the brick row 30.2 arranged thereabove is subsequently erected accordingly and subsequently the further rows of the bricks 30.3-30.6 all the way to the uppermost row 30.6.

For securing purposes, the head pieces 54 are then are fastened to the ends of the rods 40.1-40.6.

The refractory bricks 31 are subsequently arranged in the first position, wherein a clearance remains between the refractory bricks 31 and the heat-conducting layer 60 at the inner side 11 of the wall 10.

The substructure is finally removed, so that the refractory bricks 31 move into the second position illustrated in the figures by means of the force of gravity, in which the refractory bricks 31 are mounted holohedrally to the heat-conducting layer 60 arranged at the inner side 11 of the wall 10 with their side 32, which faces the inner side 11 of the wall 10.

Finally, to restrain the bricks 31 in this second position, the metal plate 50 is pushed against the upper side of the bricks 31 of the uppermost row 30.6 and welded to the upper end of the metal plates 20, 21, 22, 23.

With said metal plate 50 attached to the wall system 1 as such, the wall system 1 can be moved into any position without losing the holohedral contact between the bricks 31 and the heat-conducting layer 60.

Further, the refractory fibrous material 70 is attached to the lateral sides of the masonry.

1. A wall system (1) for a furnace, which comprises the following features:
1.1 a wall (10), which has
1.1.1 an inner side (11) facing the furnace chamber and
1.1.2 an outer side (12) facing the environment;
1.2 a heat-conducting layer (60), which
1.2.1 is arranged on the inner side (11) of the wall (10);
1.3 bearing surfaces (25), which
1.3.1 are embodied on the inner side (11) of the wall (10);
1.4 refractory bricks (31), which
1.4.1 in each case have an opening (37), which goes through the brick (31),
1.4.2 are arranged next to one another in at least one row (30.1-30.6),
1.4.3 in each case have a side (32), which faces the inner side (11) of the wall (10) and which can be mounted holohedrally to heat-conducting layer, wherein
1.4.4 the openings (37) of the bricks (31), which are in each case arranged next to one another in a row (30.1-30.6), are aligned with one another;
1.5 rods (40.1-40.6), which
1.5.1 are in each case guided through the aligned openings (37) of the bricks (31), which are arranged next to one another in a row (30.1-30.6), and
1.5.2 which in each case bear on a number of the bearing surfaces (25);
1.6 wherein the bricks (31), which are in each case arranged next to one another in a row (30.1-30.6),
1.6.1 can be moved from a first position, in which a clearance is embodied between the bricks (31) and the heat-conducting layer (60),
1.6.2 into a second position, in which the bricks (31) are mounted holohedrally to the heat-conducting layer (60) with their side (32), which faces the inner side (11) of the wall (10), by means of the force of gravity.

2. The wall system according to claim 1 comprising restraining means (50) by means of which the bricks (31) can be restrained in the second position.

3. The wall system according to at least one of the preceding claims wherein the bearing surfaces (25) run inclined downwards towards the inner side (11) of the wall (10).

4. The wall system according to at least one of the preceding claims, in the case of which the bearing surfaces (25) are embodied at different heights.

5. The wall system according to at least one of the preceding claims, in the case of which the bearing surfaces (25) are embodied at different heights, which are spaced apart evenly from one another.

6. The wall system according to at least one of the preceding claims, in the case of which at least two bearing surfaces (25) are embodied at the same height.

7. The wall system according to at least one of the preceding claims, in the case of which the bearing surfaces (25), which are in each case embodied at the same height, are spaced apart evenly from one another.

8. The wall system according to at least one of the preceding claims, in the case of which the bearing surfaces (25) are the bottom side of elongated holes (24).

9. The wall system according to at least one of the preceding claims, in the case of which the side (32) of the refractory bricks (31), which can be mounted holohedrally to the inner side (11) of the wall (10), is embodied so as to be flat.

10. The wall system according to at least one of the preceding claims, in the case of which the refractory bricks (31) are in each case embodied in a cuboidal manner.

11. The wall system according to at least one of the preceding claims, in the case of which the refractory bricks (31) are embodied uniformly.

12. A furnace, which comprises a wall system (1) according to at least one of the preceding claims.

13. The furnace according to claim 12 in the form of a furnace for melting or for treating metal.

14. The furnace according to claim 12 in the form of an electric arc furnace.

15. A method for installing a wall system, comprising the following steps:
Providing a wall system (1), according to at least one of claims 1 to 11;
positioning the bricks (31) in the first position;
moving the bricks (31) in the second position.
